(19) United States
(12) Patent Application Publication
(10) Pub. No.: US 2003/0178891 A1
(43) Pub. Date: Sep. 25, 2003

(54) Gas insulated switch

(76) Inventors: Toshihisa Miyamoto, Hitachi (JP); Mamoru Okabe, Hitachi (JP); Hitoshi Yamada, Hitachinaka (JP); Isamu Ozawa, Hitachi (JP)

Correspondence Address: Mattingly, Stanger & Malur, P.C., 104 East Hume Avenue, Alexandria, VA, 22301, US

(21) Appl. No.: 10/246,540

(22) Filed: Sep. 19, 2002

(30) Foreign Application Priority Data
Mar. 19, 2002 (JP) 2002-76099

(51) Int. Cl. H02J 1/08

(52) U.S. Cl. 307/112

(57) ABSTRACT

When each three-phase bus conductor for connecting each cable head 251 connected to a generator through a transformer to a terminal pad 100 as an air outgoing point connected to a transmission line is grounded at a part thereof existing between each gas breaker 151 to 159 and the terminal pad 100, one of the ends of a capacitor 300 is connected to the terminal pad 100 as the air outgoing point and the other end, to the ground through a support plate 302, an enclosure 318 and a support table 320.

### BACKGROUND OF THE INVENTION

1. Field of the Invention

This invention relates to a gas insulated switch. More particularly, the invention relates to an improvement in, or relating to, a fitting structure of a capacitor for suppressing a re-striking voltage that occurs when a gas breaker for opening and closing each three-phase bus conductor connected to a three-phase power system is cut off.

2. Description of the Related Art

Power transmission systems and power distribution systems among power systems employ a construction in which a switch is interposed between a transformer and a line of the system so as to cut off a line connecting the transformer and the system at the time of occurrence of an accident of the system when an output of the transformer connected to a generator is outputted.

One of the switches of this kind is a gas insulated switch into which an insulating gas such as SF₆ is filled as an insulating gas. The gas insulated switch includes a gas breaker, a disconnecting switch, a ground switch, a current detector, a voltage detector, and so forth. Each of these devices is arranged at an intermediate part of a bus accommodation casing (tank) for accommodating the three-phase bus conductors with the insulating gas. In other words, attempts have been made in the gas insulated switch to reduce the size of the switch by sealing the insulating gas inside the bus accommodation casing and reducing an insulating distance between the devices.

In the gas insulated switch, a re-striking voltage develops when the gas breaker is cut off. Therefore, the gas insulated switch employs a construction in which a capacitor is interposed between contacts of the gas breaker or between a part of the three-phase bus conductor between the breaker and the system and the ground in view of the striking voltage described above. A capacitor having tens of thousand of pF (pico-farads) is used as this capacitor.

Methods of fitting the capacitor for suppressing the re-striking voltage to the gas insulated switch includes the following two methods. The first method fits the capacitor between a part of each three-phase bus conductor between the breaker and the system and the ground, and the second fits the capacitor between contacts of the breaker (between movable contact and fixed contact). The former is more troublesome in the fitting operation than the latter. Therefore, the latter method that fits the capacitor between the contacts of the gas breaker has gained a wider application. In a tank-shaped breaker having a breaker as a single body, however, Japanese Patent Publication No. 111855/1995, for example, proposes to fit the capacitor between both ends of a bushing disposed outside the breaker in place of the contacts of the breaker.

According to the existing technologies, a capacitor for suppressing a re-striking voltage is interposed between contacts of a gas breaker that constitutes a gas insulated switch. To secure a sufficient insulating distance inside the gas breaker, the gas breaker unavoidably becomes great in size with the result of the increase of the overall size of the gas insulated switch.

### SUMMARY OF THE INVENTION

It is therefore an object of the invention to provide a gas insulated switch capable of reducing its size.

To accomplish this object, the invention provides a gas insulated switch comprising three-phase bus conductors for respectively connecting a plurality of air outgoing points each connected to each phase of a three-phase power system and a plurality of cable heads each connected to an output side of each phase of a three-phase transformer; a bus accommodation casing for accommodating the three-phase bus conductors with an insulating gas; a plurality of gas breakers arranged at intermediate positions of the bus accommodation casing, for cutting off the three-phase bus conductors in accordance with a cutoff instruction; and a plurality of capacitors for respectively connecting each of the three-phase conductors existing between each gas breaker and the gas outgoing point to the ground.

To constitute the gas insulated switch, a plurality of capacitors described above may have a construction in which each three-phase bus conductor existing between each breaker and each gas outgoing point is connected to the ground or to a ground potential point, and the capacitors may be arranged inside the bus accommodation casing.

A plurality of capacitors described above may have a construction in which each gas outgoing point is connected to the ground or to a ground potential point, and the capacitors may be arranged outside the bus accommodation casing.

The following constituent elements may be added when each gas insulated switch is constituted.

(1) A plurality of capacitors comprises those capacitors which have a capacitance for suppressing a re-striking voltage that occurs when each gas breaker is cut off.

(2) The gas insulated switch further includes a plurality of switches for respectively grounding or switching the three-phase bus conductors, a plurality of current detectors for respectively detecting currents of the three-phase bus conductors and a plurality of voltage detectors for respectively detecting voltages of the three-phase bus conductors, and wherein a plurality of switches, a plurality of current detectors and aplurality of voltage detectors are arranged at intermediate positions of the bus accommodation casing.

The means described above connects each three-phase bus conductor existing between each gas breaker and each air out going point or each air outgoing point to the ground or to a ground potential point by use of a capacitor. Therefore, the gas breaker can be made smaller in size than when the capacitor is interposed between contact of the gas breaker, and the overall size of the gas insulated switch can be reduced as a whole. When the capacitor of each phase is arranged outside the bus accommodation casing, the size of the bus accommodation casing can be made smaller than when the capacitor is arranged inside the bus accommodation casing.

### BRIEF DESCRIPTION OF THE DRAWINGS

FIG. 1 is a top view of a gas insulated switch according to an embodiment of the invention;

FIG. 2 is a skeleton diagram of the gas insulated switch shown in FIG. 1;

FIG. 3 is a view taken along a line A-A′ in FIG. 1;

FIG. 4 is a view taken along a line B-B′ in FIG. 1;

FIG. 5 is a structural explanatory view of a bushing to which a capacitor is fitted;

FIG. 6A is a sectional view of a terminal pad;

FIG. 6B is a right side view of the terminal pad;

FIG. 6C is a left side view of the terminal pad;

FIG. 7 is a view taken along a line C-C′ in FIG. 5;

FIG. 8 shows another embodiment of the invention, wherein:

FIG. 8A is an explanatory view useful for explaining the relation between a bushing and a tank; and

FIG. 8B is an equivalent circuit diagram.

### DESCRIPTION OF THE PREFERRED EMBODIMENTS

Preferred embodiments of the invention will be hereinafter explained with reference to the accompanying drawings.

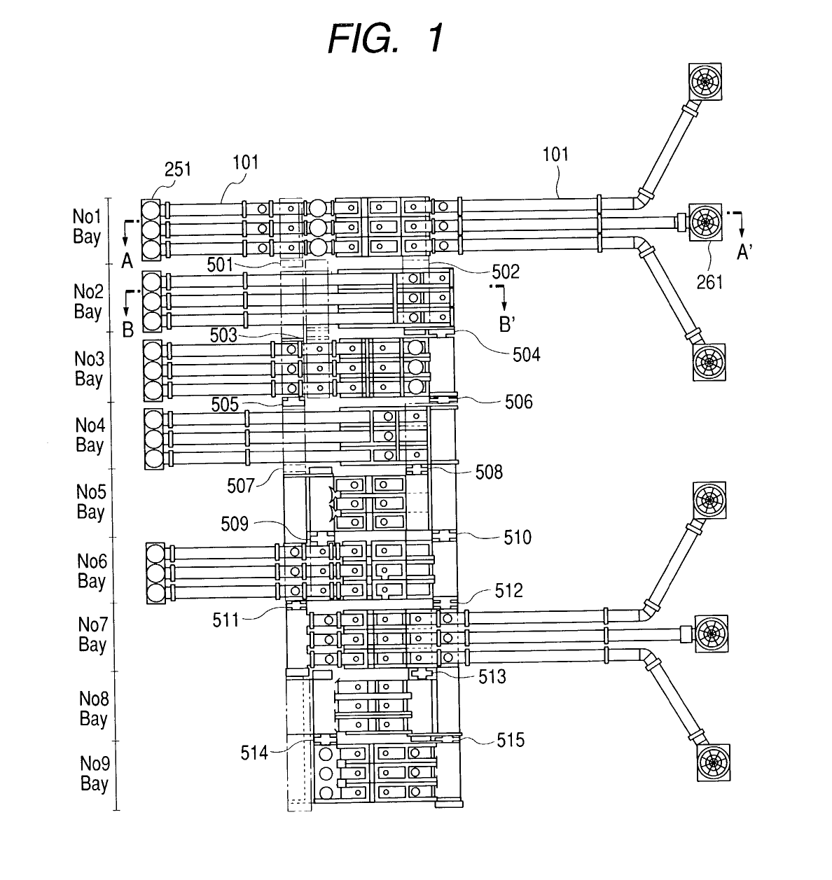

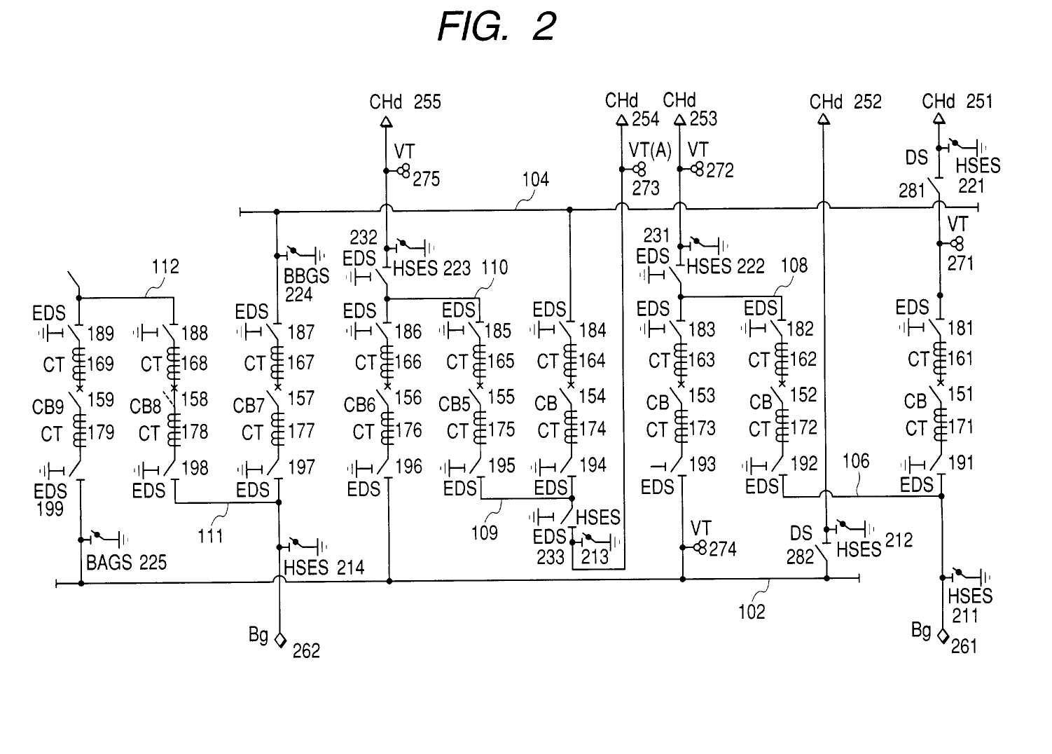

FIG. 1 is a top view that shows a gas insulated switch (GIS) according to an embodiment of the invention. FIG. 2 is a skeletal diagram showing skeletally circuit portions corresponding to three phases in the gas insulated switch shown in FIG. 1.

Referring to FIGS. 1 and 2, the gas insulated switch according to this embodiment employs a 1-½ bus system. A cable head (CHd) 251 corresponding to each phase of a three-phase power system is connected to the output side of each phase of a three-phase transformer (not shown in the drawings). The input side of each phase of the three-phase transformer is connected to a generator (not shown). A bushing 261 supports a terminal pad 100 that is connected to each phase of a transmission line constituting a transmission system of the three-phase power system, as an air outgoing point. The end portion of the terminal pad 100 is connected to that of the cable head 251 through a three-phase bus conductor (not shown). The bus conductor of each phase is accommodated with an insulating gas SF₆ inside a bus accommodation casing 101. The generator transmits its power to the transmission line through the transformer, the cable head 251, the three-phase bus conductor and the terminal pad 100. The bus accommodation casing 101 is so divided into nine bay units Nos. 1 to 9 as to correspond to nine breakers 151 to 159. Bellows connection portions 501 to 515 are arranged at intermediate positions of the bus accommodation casing 101 of each unit. The bellows connection portion 501 to 515 are arranged in a direction in which three-phase collective buses 102 and 104 extend, and are connected to one another. Further, the bellows connection portions 501 to 515 are assembled into a hermetic structure sealing therein the SF₆ gas as one of the constituents of the bus accommodation casing 101. Incidentally, the term three-phase collective buses 102 and 104″ is a generic term of the bus conductors of each of the three phases collectively accommodated in the bus accommodation casing 101.

The gas insulated switch according to this embodiment includes nine gas breakers (CB1 to CB9) respectively corresponding to the nine bay units Nos. 1 to 9. Metering current transformers (CT) as a current detector, potential transformers (VT) as a voltage detector, three-position disconnecting/earth switches (EDS) and earth switches (HSES) are disposed on both sides of each gas breaker. However, only bay units Nos. 1 and 2 will be hereinafter explained for ease of explanation.

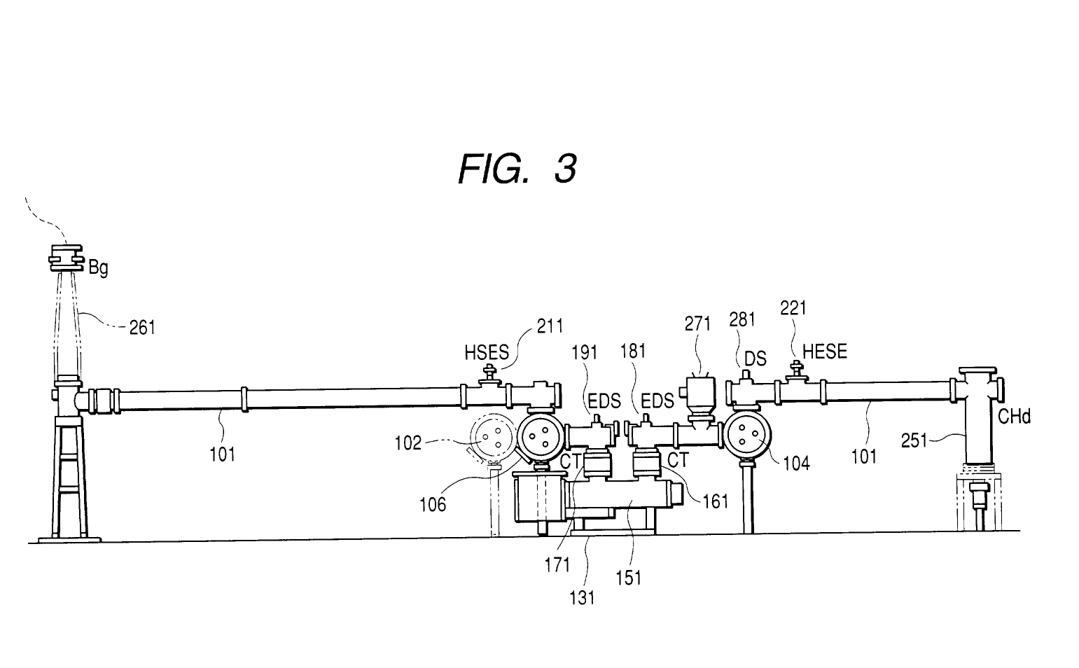

Referring initially to the bay unit No. 1, the bus conductor of each phase is so arranged as to extend along the bus accommodation casing 101 from the cable head 251 of each phase connected to the generator through the transformer as shown in FIG. 3 (sectional view taken along a line A-A′ in FIG. 1). The bus conductor of each phase is arranged as the three-phase collective bus 104 inside the bus accommodation casing 101 through a high-speed operation earth switch (HSES) 221 and a disconnecting switch (DS) 281. The bus conductor of each phase thus accommodated as the three-phase collective bus 104 is arranged in a triangular shape with the bus conductor of each bus as an apex inside the bus casing 101. The bus conductor of each phase is thereafter taken out for each phase in a horizontal direction and is connected to the three-position disconnecting/earth switch (EDS) 181 through the meter transformer (VT) 271. The bus conductor of each phase is taken down out from this disconnecting/earth switch (EDS) 181 in a vertical direction and is connected to a gas breaker (GCB) 151 of each phase through the potential transformer (CT) 161. The gas breaker (GCB) 151 is arranged in the horizontal direction on a base 131 and is so constituted as to break the bus conductor in response to a breaking instruction from a controller (not shown) at the time of accident of the system.

After taken out upward from the gas breaker (GCB) 151 in the vertical direction, the bus conductor of each phase is connected to the disconnecting/earth switch (EDS) 191 through the meter transformer (CT) 171. From this disconnecting/earth switch (EDS) 191. the bus conductor of each phase is accommodated as the three-phase collective bus 106 in the horizontal direction inside the bus accommodation casing 101. A part of the bus conductor of each phase is connected to the gas breaker (GCB) 152 of the bay unit No.2 while the bus conductors of the remaining phases are separated from the three-phase collective bus 106 and are connected to the terminal pad 100 of the bushing (Bg) 261 through the earth switch (HSES) 211. Incidentally, the bus accommodation casing 101 accommodating therein the three-phase collective buses 102, 104 and 106 is installed by use of a support member on an installation surface.

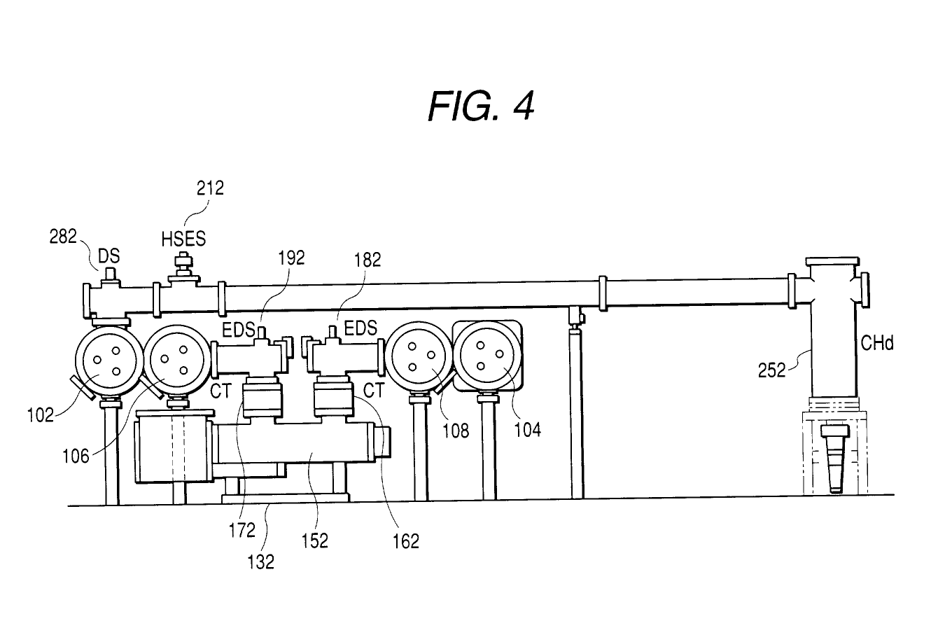

In the bay unit No. 2, on the other hand, the bus conductor of each phase extends from the cable head (CHd) 252 connected to the generator through the transformer, and is accommodated as the three-phase collective bus 102 inside the bus accommodation casing 101 through the earth switch (HSES) 212 and the breaker (DS) 282 as shown in FIG. 4 (sectional view taken along line B-B′ in FIG. 1).

The bus conductor of each phase connected to the bay unit No. 1 and accommodated as the three-phase collective bus 106 in the bus accommodation casing 101 is taken out for each phase in the horizontal direction, is connected to the disconnecting/earth switch (EDS) 192, is then taken out downward in the vertical direction and is connected to the gas breaker (GCB) 162 through the metering current transformer (CT) 172. From the gas breaker (GCB) 152, the bus conductor of each phase is taken out upward in the vertical direction for each phase, passes through the metering current transformer (CT) 162, is accommodated as the three-phase collective bus 108 in the bus accommodation casing 101 through the disconnecting/earth switch (EDS) 182 and is arranged in the horizontal direction. Incidentally, the bus conductor of each phase accommodated as the three-phase collective bus 102 and 104 inside the bus accommodation casing 101 is not connected to the circuit of the gas breaker (GCB) 152 inside the bay unit No. 2.

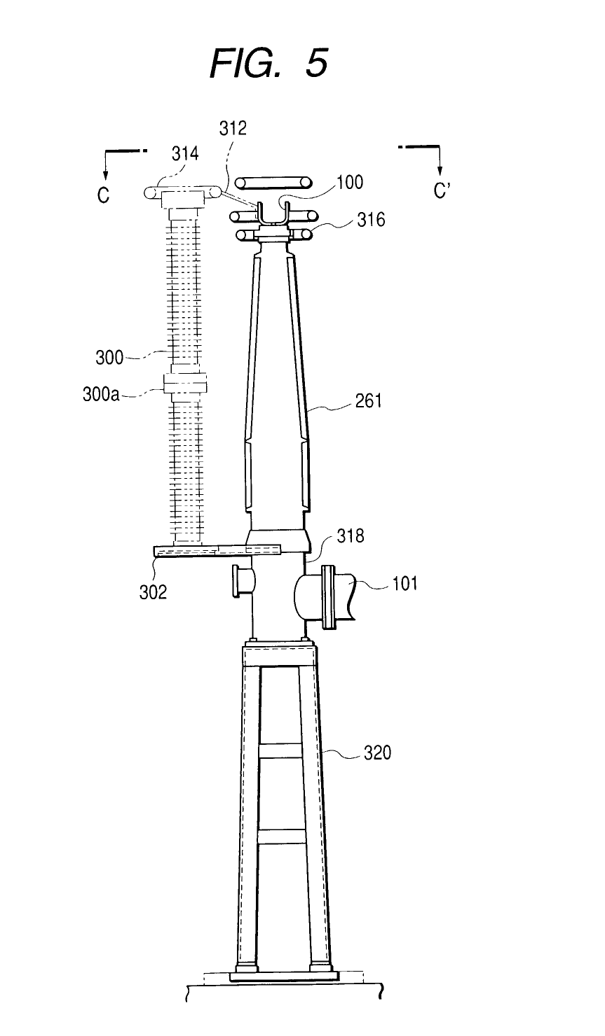

When a capacitor for suppressing a re-striking voltage that occurs when the breakers 151 to 159 of each phase is cut off is disposed, the invention connects the three-phase bus conductor between each gas breaker of the three-phase bus conductor and each air outgoing point, or the air outgoing point, to the ground or a ground potential point by use of the capacitor. In this embodiment, a capacitor 300 having a capacitance for suppressing the re-striking voltage is connected at one of its ends to a metal pad 100 and at the other end, to the ground through a support plate 302 as shown in FIG. 5.

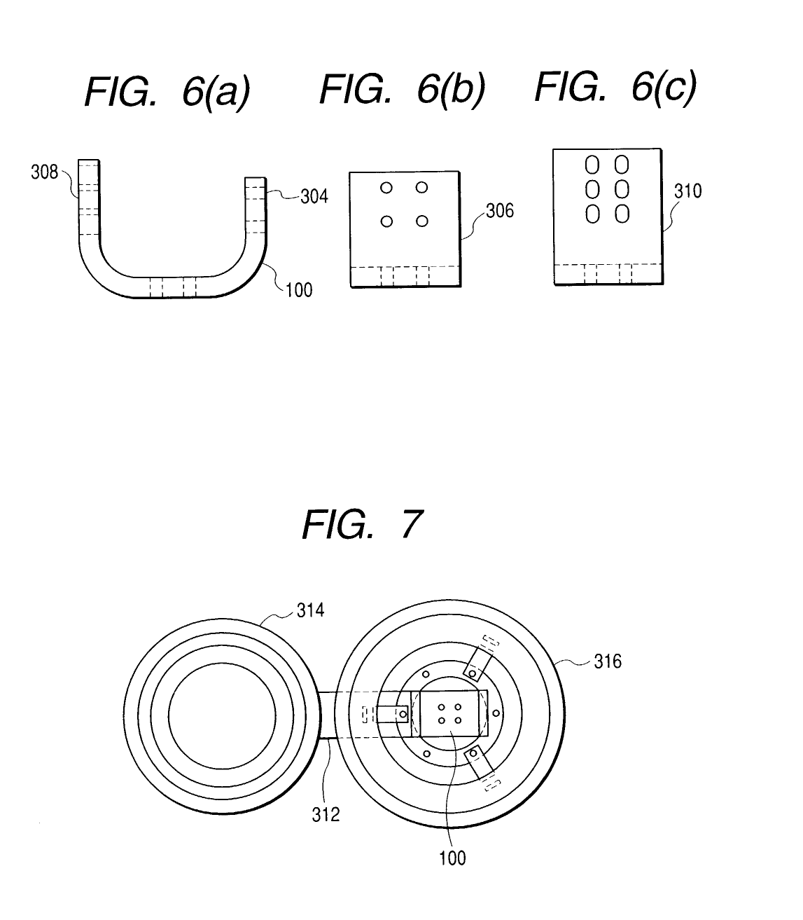

More concretely, the terminal pad 100 made of copper is fixed to the top of the bushing 261 and is connected to the bas conductor of one phase accommodated inside the bushing 261. The copper terminal pad 100 has a substantial U-shape as shown in FIG. 6. A fitting metal 306 is fixed into a fitting hole 304 formed at one of the ends of the terminal pad 100 through bolt/nut, and a transmission line is connected through this fitting metal 306. Another fitting metal 310 is fixed into a fitting hole 308 formed at the other end of the terminal pad 100 through a bolt/nut. A lead wire 312 connected to the fitting metal 310 is connected to one of the ends of the capacitor 300 through a metal support plate 314. Incidentally, the capacitor 300 has two capacitors connected to each other in series through a connecting plate 300a to form one capacitor as a whole.

The terminal pad 100 serves also as the air outgoing point at which the bus conductor is taken out from the bushing 261 into air. Therefore, a shield ring 316 made of aluminum is arranged around the terminal pad 100 as shown in FIG. 7, and is fixed to the top of the bushing 261.

On the other hand, an enclosure 318 connected to the bottom of the bushing 261 is formed of a stainless steel into a substantial cylindrical shape. The bus accommodation casing 101 is connected to the enclosure 318 and a support plate 302 made of a stainless steel is also fixed to the enclosure 318. The enclosure is fixed at its bottom to a support table 320 made of a steel, and is buried at its bottom into the ground for grounding.

One of the ends of the capacitor 300 is connected to the support plate 302. The capacitor 300 is grounded through the support plate 302, the enclosure 318 and the support table 320. The support plate 302, the enclosure 318 and the support table 320 function as a ground potential point having substantially the same potential as the ground. One of the ends of the capacitor 300 is connected to the ground potential point and is grounded.

When each three-phase base conductor between each gas breaker and each terminal pad 100 of the three-phase bus conductors is grounded, this embodiment connects the terminal pad 100 as the air outgoing point of each phase to the ground potential point or the ground through the capacitor 300 as described above. Therefore, the embodiment can fabricate the gas breaker into a smaller size than when the capacitor 300 is connected between the contacts of the gas breaker of each phase, and can eventually reduce the size of the gas insulated switch as a whole.

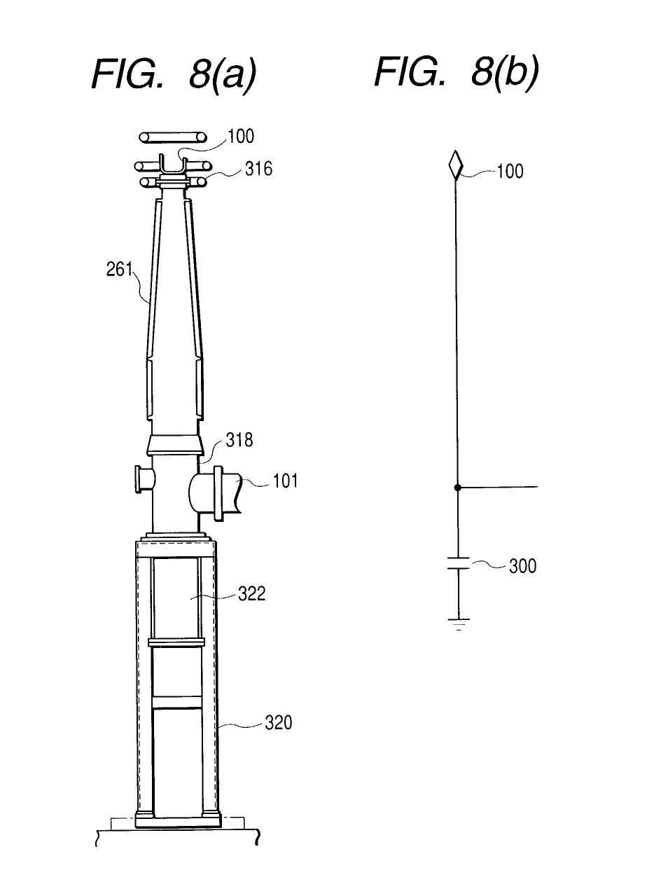

Next, another embodiment of the invention will be explained with reference to FIG. 8. When each three-phase bus conductor between the gas breaker and the air outgoing point among the three-phase bus conductors is grounded, this embodiment connects the bushing 261 and the bus conductor accommodated inside the enclosure 318 to the ground potential point or to the group through the capacitor 300.

A tank 322 having the capacitor 300 built therein is arranged above the support table 320, and the upper side of the tank 322 is connected to the bottom side of the enclosure 318. The tank 322 made of a stainless steel is connected to the ground through the support table 320. One of the ends of the capacitor 300 accommodated inside the tank 322 is connected to the wall of the tank 322 and to the ground through the wall. On the other hand, the other end of the capacitor 300 is connected to the bus conductor accommodated in the enclosure 318.

This embodiment connects each three-phase bus conductor between the gas breaker and the air outgoing point among the three-phase bus conductors to the ground potential point or to the ground through the capacitor 300. Therefore, this embodiment can make the gas breaker smaller than when the capacitor 300 is connected between the contacts of the gas breaker and can eventually reduce the overall size of the gas insulated switch. Because the capacitor 300 is not taken out into air (open air) in this embodiment, the fitting operation of the capacitor 300 becomes easier than in the foregoing embodiment, and the fitting space of the capacitor 300 becomes smaller, too.

As explained above, this invention connects each three-phase bus conductor between the gas breaker and the air outgoing point, or the air outgoing point, to the ground or the ground potential point through the capacitor. Therefore, the invention can make the gas breaker smaller than when the capacitor is connected between the contacts of the gas breaker and can eventually reduce the overall size of the gas insulated switch.

1. A gas insulated switch comprising:
three-phase bus conductors for respectively connecting a plurality of air outgoing points each connected to each phase of a three-phase power system and a plurality of cable heads each connected to an output side of each phase of a three-phase transformer;
a bus accommodation casing for accommodating said three-phase bus conductors with an insulating gas;
a plurality of gas breakers arranged at intermediate positions of said bus accommodation casing, for cutting off said three-phase bus conductors in accordance with a cutoff instruction; and
a plurality of capacitors for respectively connecting each of said three-phase conductors existing between said gas breaker and said gas outgoing point to the ground.

2. A gas insulated switch comprising:
three-phase bus conductors for respectively connecting a plurality of air outgoing points each connected to each phase of a three-phase power system and a plurality of cable heads each connected to an output side of each phase of a three-phase transformer;
a bus accommodation casing for accommodating said three-phase bus conductors with an insulating gas;
a plurality of gas breakers arranged at intermediate positions of said bus accommodation casing, for cutting off said three-phase bus conductors in accordance with a cutoff instruction; and
a plurality of capacitors for respectively connecting each of said three-phase conductors existing between said gas breaker and said gas outgoing point to the ground;
wherein said plurality of capacitors are arranged inside said bus accommodation casing.

3. A gas insulated switch comprising:
three-phase bus conductors for respectively connecting a plurality of air outgoing points each connected to each phase of a three-phase power system and a plurality of cable heads each connected to an output side of each phase of a three-phase transformer;
a bus accommodation casing for accommodating said three-phase bus conductors with an insulating gas;
a plurality of gas breakers arranged at intermediate positions of said bus accommodation casing, for cutting off said three-phase bus conductors in accordance with a cutoff instruction; and
a plurality of capacitors for respectively connecting each of said gas outgoing point to the ground;
wherein said plurality of capacitors are arranged outside said bus accommodation casing.

4. A gas insulated switch according to any of claims 1 through 3, wherein said plurality of capacitors have a capacitance for suppressing a re-striking voltage occurring when each of said gas breakers is cut off.

5. A gas insulated switch according to any of claims 1 through 4, which further includes a plurality of switches for respectively grounding or switching said three-phase bus conductors, a plurality of current detectors for respectively detecting currents of said three-phase bus conductors, and a plurality of voltage detectors for respectively detecting voltages of said three-phase bus conductors, and wherein said plurality of switches, said plurality of current detectors and said plurality of voltage detectors are arranged at intermediate positions of said bus accommodation casing.
